(19) United States
(12) Patent Application Publication
(10) Pub. No.: US 2005/0044706 A1
(43) Pub. Date: Mar. 3, 2005

(54) Method of and apparatus for cracking connecting rod

(76) Inventor: Yasuo Momose, Utsunomiya-shi (JP)

Correspondence Address: BIRCH STEWART KOLASCH & BIRCH, PO BOX 747, FALLS CHURCH, VA, 22040-0747, US

(21) Appl. No.: 10/915,389

(22) Filed: Aug. 11, 2004

(30) Foreign Application Priority Data
Aug. 28, 2003 (JP) 2003-305189

(51) Int. Cl. B26F 3/00; B26F 3/02

(52) U.S. Cl. 29/888.09; 29/426.5; 29/426.4; 225/97; 225/103

(57) ABSTRACT

A cracking apparatus has a pair of spreaders to be placed in a joint hole defined in a larger end of a connecting rod, a wedge that is pressed in between the spreaders, a preloading mechanism for imparting a preload to the wedge, and a loading mechanism for imparting an impact load to the wedge in the direction in which the wedge is pressed, by energizing a rotational drive source and transmitting rotational drive power from the rotational drive source through a shaft connected to the wedge, after the preload has been applied to the wedge by the preloading mechanism.

### BACKGROUND OF THE INVENTION

1. Field of the Invention

The present invention relates to a method of and an apparatus for cracking a one-piece connecting rod, which serves as an engine component for vehicles and which has a larger end and a smaller end, to fracture the larger end into a cap and a rod.

2. Description of the Related Art

Heretofore, connecting rods interconnecting piston pins and crank pins have widely been used in vehicular engines. Each of the connecting rods has a larger end coupled to the crankpin and a smaller end coupled to the piston pin. For manufacturing a connecting rod, it is generally customary to produce a one-piece connecting rod having a larger and a smaller end and thereafter to fracture the larger end into a cap and a rod.

One conventional process of fracturing a connecting rod will be described below.

As shown in FIG. 17 of the accompanying drawings, a one-piece connecting rod 5 includes a shank 1 having a smaller end 2 and a larger end 3 with a cap 4 integrally formed therewith. The connecting rod 5 is held by a pair of jigs 6, 7 fixed to each other with the larger end 3 and the cap 4 being retained therein. A pressurizing hose 8 comprising a rubber layer or the like is inserted in a larger end hole 3a defined in the larger end 3 and supplied with a liquid under pressure, for applying a constant static pressure to the entire inner surface of the larger end hole 3a. Under the applied pressure, the larger end 3 is fractured from a pair of cracking slots 9a, 9b that are defined on the inner surface of the larger end hole 3a. The larger end 3 is fractured into the cap 4 and the shank 1 without suffering undue strains. If a plurality of connecting rods 5 and a plurality of sets of jigs 6, 7 are arranged on the pressurizing hose 8, then many connecting rods 5 can be cracked simultaneously. For details, reference may be made to Japanese Laid-Open Patent Publication No. 11-245122, for example.

Since the pressurizing hose 8 is supplied with the pressurizing liquid and the larger end 3 is fractured under the pressure of the pressurizing liquid, it is difficult to control the pressure of the pressurizing liquid highly accurately when the larger end 3 is fractured. Therefore, it is difficult to control, with high accuracy, the value of a load imposed through the pressurizing hose 8 to the larger end 3, and the period of time for which the load is applied to the larger end 3.

When the larger end 3 is fractured, accordingly, the fracturing load applied through the pressurizing hose 8 to the larger end 3 is unstable, resulting in difficulties in stabilizing and maintaining the product quality of the connecting rod 5 at a highly accurate level, and also resulting in a reduction in the productivity of the connecting rod 5.

### SUMMARY OF THE INVENTION

It is a general object of the present invention to provide a method of and an apparatus for cracking a connecting rod by highly accurately controlling the magnitudes of a preload and an impact load that are applied to fracture the connecting rod, while also controlling the periods of time for which the preload and the impact load are applied.

The above and other objects, features and advantages of the present invention will become more apparent from the following description when taken in conjunction with the accompanying drawings in which preferred embodiments of the present invention are shown by way of illustrative example.

### BRIEF DESCRIPTION OF THE DRAWINGS

FIG. 1A is a perspective view of a one-piece connecting rod to which the present invention is applied;

FIG. 1B is a perspective view of the connecting rod as it is fractured into a cap and a rod;

FIG. 2 is a front elevational view, partly in cross section, of a cracking apparatus according to a first embodiment of the present invention;

FIG. 3 is a side elevational view, partly in cross section, of the cracking apparatus shown in FIG. 2;

FIG. 4 is an enlarged fragmentary plan view of the cracking apparatus;

FIG. 5 is a perspective view of a workpiece holding mechanism of the cracking apparatus;

FIG. 6A is an enlarged fragmentary plan view of a fracturing mechanism of the cracking apparatus;

FIG. 6B is an enlarged fragmentary cross-sectional view of the fracturing mechanism;

FIG. 7 is a perspective view of a rotor having a guide engaged by first and second rollers;

FIG. 8 is an enlarged front elevational view, partly in cross section, showing the manner in which the connecting rod is preloaded by a preloading mechanism of the cracking apparatus;

FIG. 9 is an enlarged front elevational view, partly in cross section, showing the manner in which an impact load is applied to the connecting rod by a loading mechanism of the cracking apparatus;

FIG. 10 is a view illustrative of shape differences in the circumferential direction of the guide of the rotor;

FIG. 11 is a diagram showing a pattern representative of the cross-sectional shape of the guide of the rotor;

FIG. 12 is a diagram showing the stroke of a shaft, the angular displacement of the rotor, and the rotational speed of the rotor upon rotation of the rotor;

FIG. 13 is a diagram showing the relationship between the load applied to the connecting rod and the period of time in which the load is applied to the connecting rod;

FIG. 14 is a block diagram showing an operation sequence for detecting the load applied to the connecting rod and for managing the quality of the connecting rod in the cracking apparatus;

FIG. 15 is a schematic elevational view of a cracking apparatus according to a second embodiment of the present invention;

FIG. 16 is a schematic elevational view of a cracking apparatus according to a third embodiment of the present invention; and

FIG. 17 is a cross-sectional view illustrative of a conventional process of fracturing a connecting rod.

### DESCRIPTION OF THE PREFERRED EMBODIMENTS

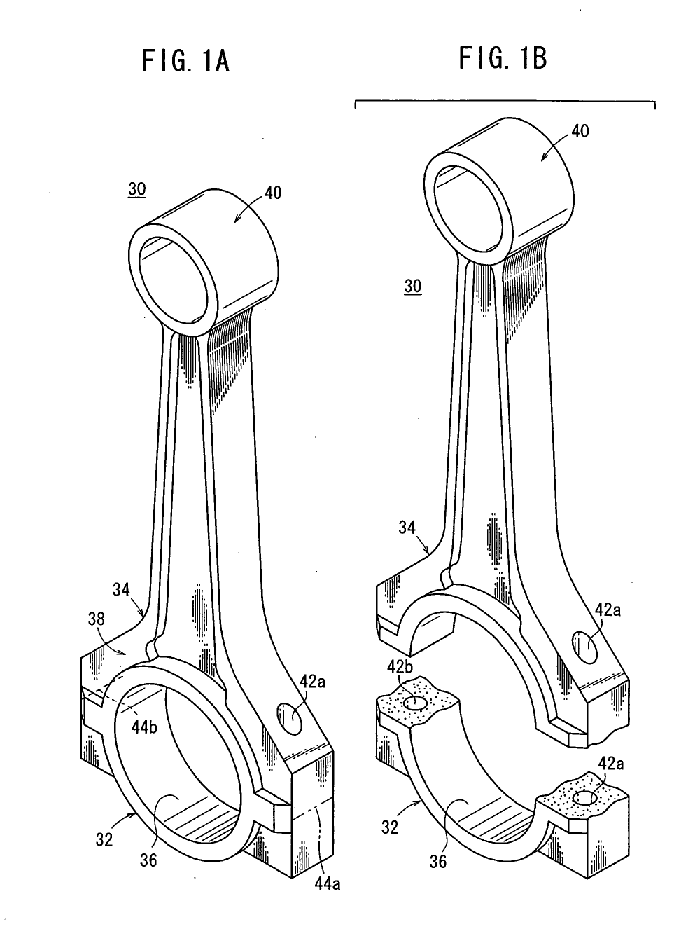

FIG. 1A shows in perspective a one-piece connecting rod 30 as a workpiece to which the present invention is applied, and FIG. 1B shows in perspective the connecting rod 30 as it is fractured into a cap 32 and a rod 34.

As shown in FIGS. 1A and 1B, the connecting rod 30 has a larger end 38 comprising an integral structure made up of the cap 32 and the rod 34 with a substantially circular joint hole 36 defined therebetween, and a smaller end 40 positioned remotely from the larger end 38. The connecting rod 30 may be integrally produced by casting, forging, or the like.

The larger end 38 has a pair of bolt holes 42a, 42b defined in opposite sides thereof by a boring mechanism (not shown) such as a drill or the like. In a process of assembling an engine, bolts (not shown) are threaded from the cap 32 into respective bolt holes 42a, 42b, thereby fastening the cap 32 to the rod 34. The fractured cap 32 is thus fastened to the rod 34, and the larger end 38 of the connecting rod 30 is connected to a crank pin of the engine.

In FIG. 1A, the larger end 38 has a pair of cracking areas 44a, 44b positioned as boundary areas between the cap 32 and the rod 34. The cracking areas 44a, 44b are located in opposite sides of the larger end 38, disposed diametrically across the joint hole 36.

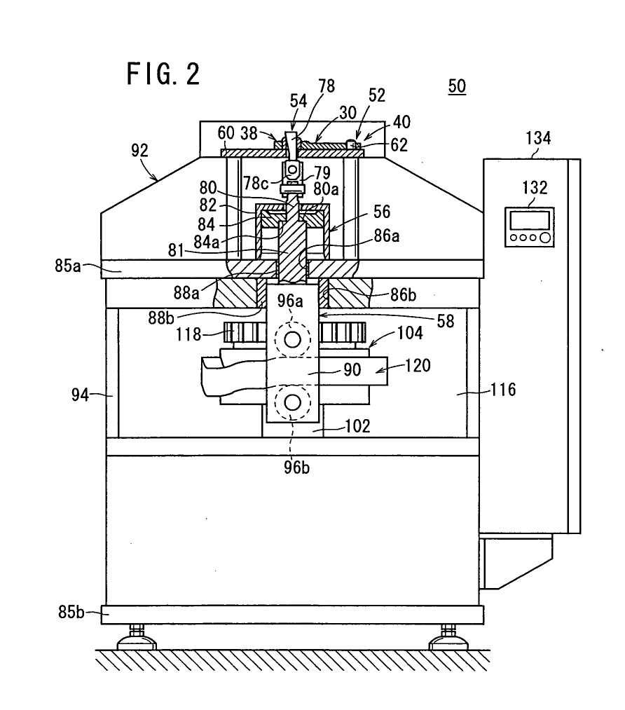

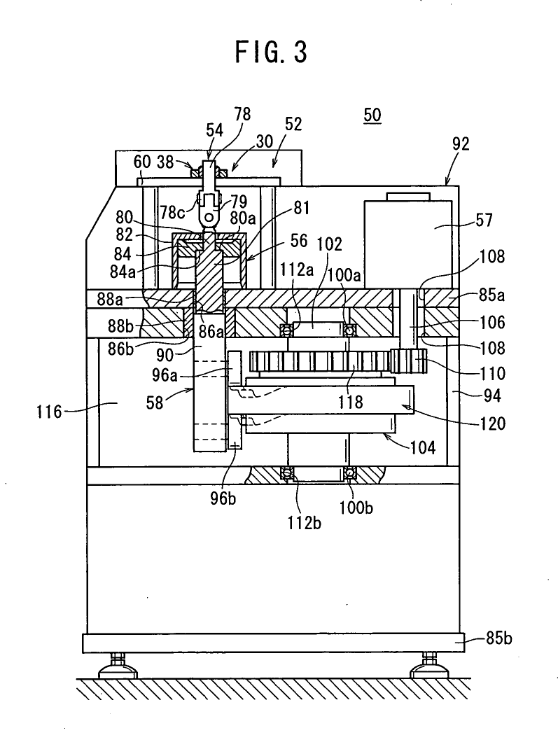

FIGS. 2 and 3 show a cracking apparatus 50 for cracking the connecting rod 30 according to a first embodiment of the present invention. The cracking apparatus 50 comprises a workpiece holding mechanism 52 for holding the connecting rod 30, a fracturing mechanism 54 for fracturing the larger end 38 of the connecting rod 30, a preloading mechanism 56 for preloading the fracturing mechanism 54, and a loading mechanism 58 for applying an impact load to the fracturing mechanism 54 by operating a rotational drive source 57.

The workpiece holding mechanism 52, the fracturing mechanism 54, and the preloading mechanism 56 are mounted in a casing 92 and supported on an upper end plate 85a of the casing 92. The loading mechanism 58 is mounted in a casing frame 94 disposed beneath the upper end plate 85a and supported on a lower end plate 85b of the casing 92.

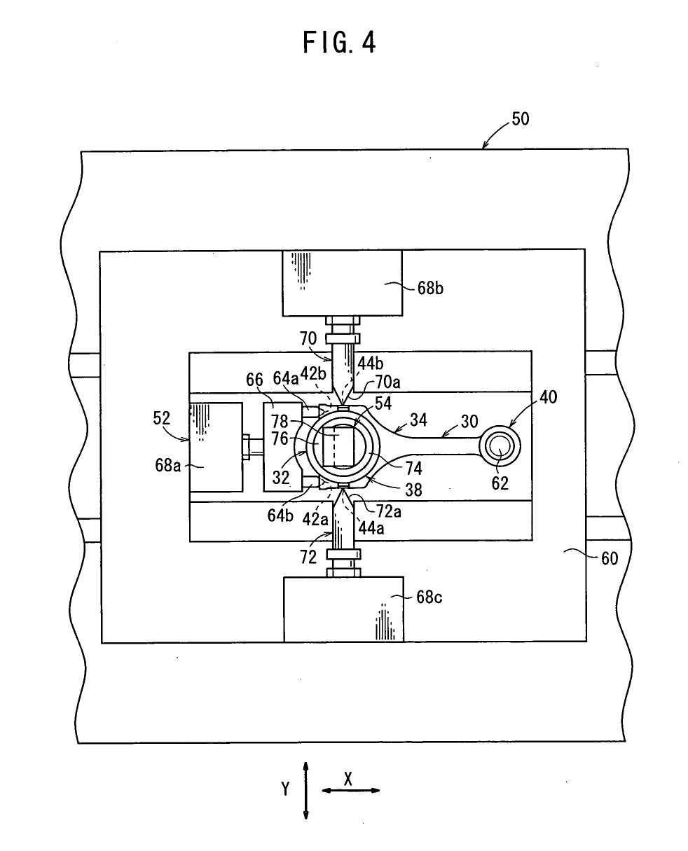

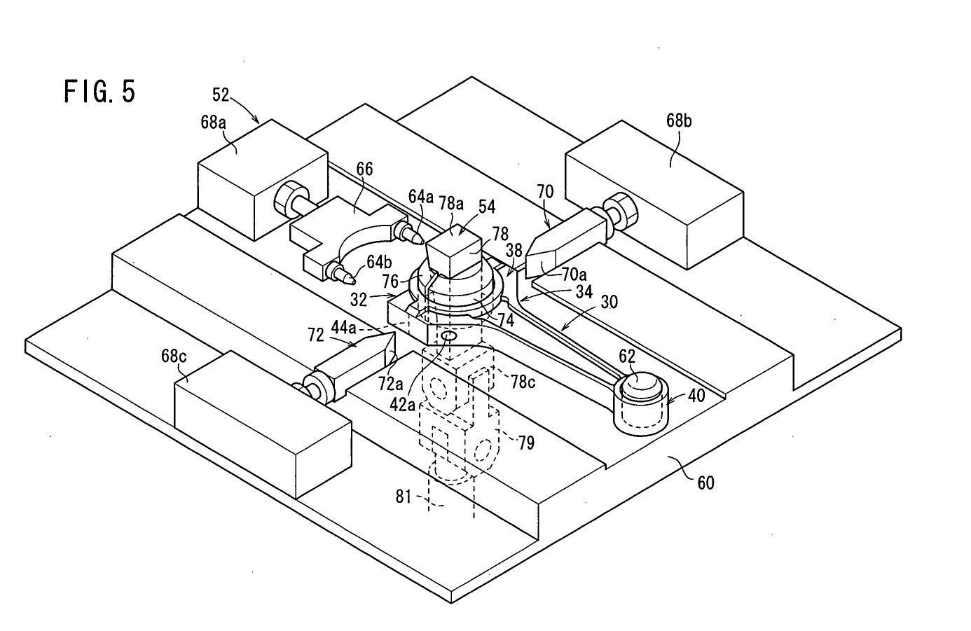

As shown in FIGS. 4 and 5, the workpiece holding mechanism 52 comprises a support base 60 for supporting the connecting rod 30 thereon, a fixing pin 62 for positioning and fixing the connecting rod 30 at its smaller end 40, and a pair of slide pins 64a, 64b oriented toward the bolt holes 42a, 42b for holding the connecting rod 30 at its larger end 38 laterally in the direction indicated by the arrow X in FIG. 4.

The slide pins 64a, 64b are connected to a hydraulic cylinder 68a by a slide plate 66. The hydraulic cylinder 68a is used to reliably hold the connecting rod 30 at its larger end 38 and also to reliably prevent the cap 32 from being scattered when it is fractured from the larger end 38. In the first embodiment, the hydraulic cylinder 68a applies a load adjustable in the range from about 0 to 490 newtons (N), for example, to the connecting rod 30.

As shown in FIG. 4, the workpiece holding mechanism 52 may have a pair of pressers 70, 72 for pressing the cracking areas 44a, 44b of the larger end 38 from its opposite sides in the direction indicated by the arrow Y. The pressers 70, 72 have sharply pointed abutment edges 70a, 72a disposed respectively on ends thereof. The pressers 70, 72 have opposite ends coupled to respective hydraulic cylinders 68b, 68c remotely from the abutment edges 70a, 72a.

The fracturing mechanism 54 has a pair of spreaders 74, 76 which are set in the larger end 38 of the joint hole 36, and a wedge 78 which is pressed in between the spreaders 74, 76 for spreading the spreaders 74, 76 away from each other.

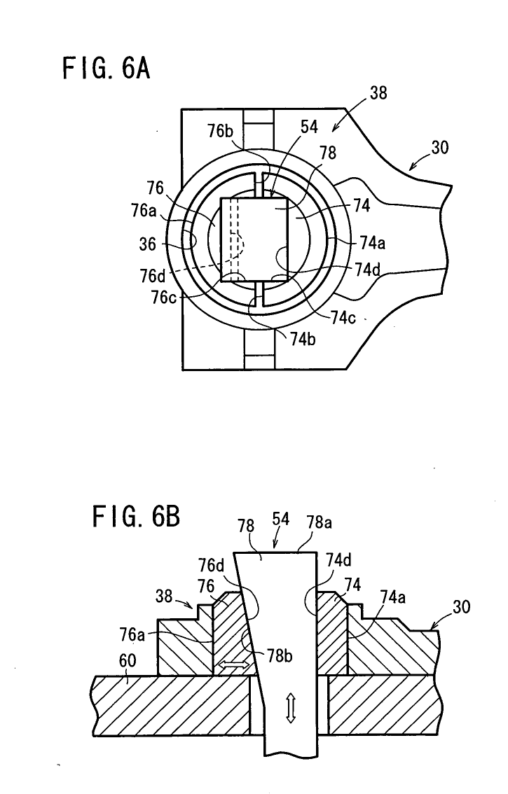

As shown in FIGS. 6A and 6B, the spreaders 74, 76 are each of a substantially semicircular shape in plan view, and have respective arcuate portions 74a, 76a and straight portions 74b, 76b. The arcuate portions 74a, 76a have a curvature that is substantially identical to the curvature of the inner surface of the joint hole 36, and can be pressed against the inner surface of the joint hole 36. The straight portions 74b, 76b have respective recesses 74c, 76c defined centrally therein for receiving the wedge 78. Of these recesses 74c and 76c, the recess 74c has a wall 74d generally shaped as an upstanding wall, and the other recess 76c has a wall 76d shaped as a tapered wall that is progressively inclined outwardly in the upward direction (see FIG. 6B).

The wedge 78 has a tapered surface 78b on one side thereof that is progressively inclined outwardly in the upward direction toward an upper end 78a of the wedge 78. The wedge 78 is fitted in the recesses 74c, 76c such that the tapered surface 78b is held in sliding contact with the tapered wall 76d of the spreader 76. When the wedge 78 is urged (pulled) downwardly, the tapered surface 78b slides against the tapered wall 76d, forcing the spreader 76 to move away from the other spreader 74.

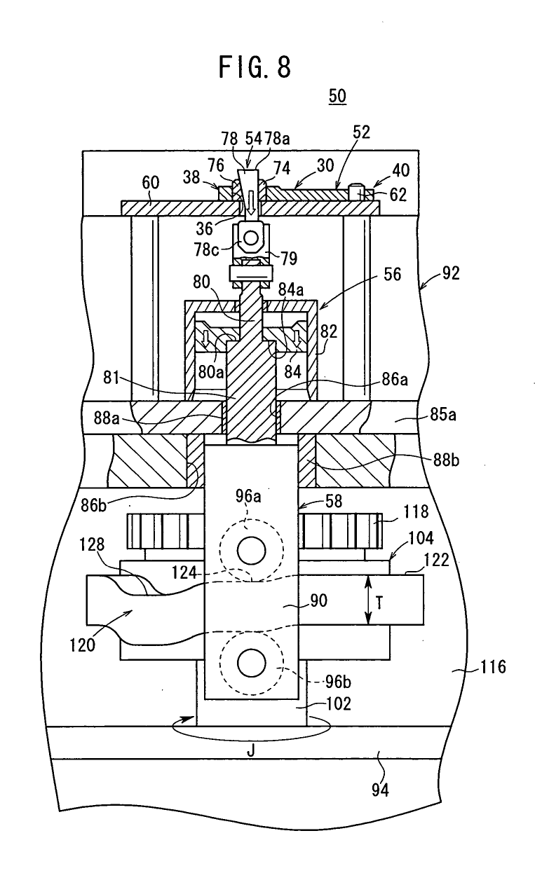

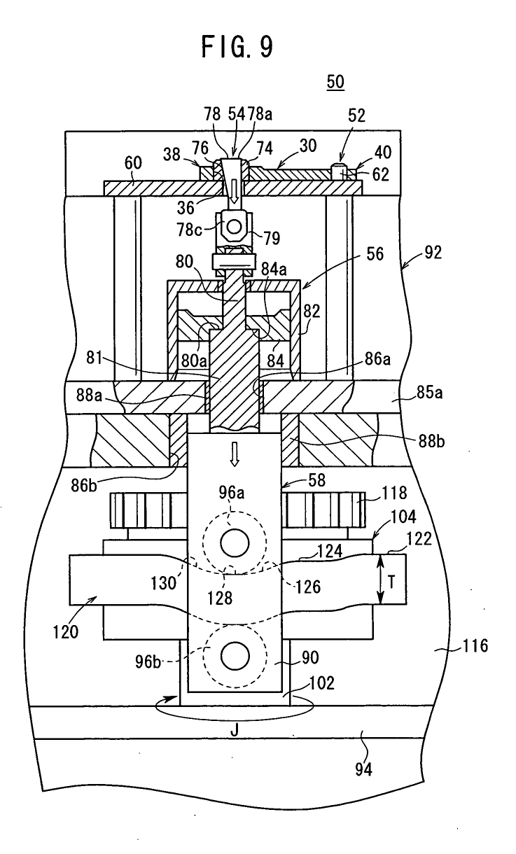

As shown in FIGS. 2 and 3, the preloading mechanism 56 has a hydraulic cylinder 82 for producing a preload to be applied to the wedge 78. The hydraulic cylinder 82 comprises a piston rod (load transmitter) 80 coupled to the lower end 78c of the wedge 78 by a joint 79 such as a joint pin or the like, and a piston 84 having a step 84a (see FIGS. 8 and 9) engaging an annular step surface 80a of the piston rod 80.

The piston rod 80 extends centrally through the piston 84 and is slidable with respect to the piston 84. The piston 84 of the hydraulic cylinder 82 is displaceable in unison with the piston rod 80 in the direction in which the wedge 78 is pressed, i.e., pulled downwardly. The piston 84 is also movable with respect to the piston rod 80 in a direction opposite to the direction in which the wedge 78 is pressed. Stated otherwise, the hydraulic cylinder 82 causes the piston 84 to apply a preload to the fracturing mechanism 54 only in one longitudinal direction of the piston rod 80. The preload applied to the wedge 78 is adjustable in the range from about 0 to 49 kN, for example.

The preloading mechanism 56 has a load transmitting shaft (load transmitter) 81 coupled to the wedge 78 by the piston rod 80. The shaft 81 has an end integral with the piston rod 80 at the step surface 80a. The shaft 81 is inserted in a hole 86a defined in the upper end plate 85a of the casing 92, and is axially displaceably supported by a bushing 88a mounted in the hole 86a. The other end of the shaft 81 is integrally joined to a vertical joint shaft 90 which is larger in diameter than the shaft 81. The joint shaft 90 is axially displaceably supported by a bushing 88b mounted in a hole 86b defined in the casing frame 94.

First and second rollers 96a, 96b are rotatably supported on a side of the joint shaft 90 that faces the loading mechanism 58 (see FIGS. 2 and 3). The first and second rollers 96a, 96b are each substantially of a circular shape, have respective axes substantially perpendicular to the axis of the shaft 81, and are spaced a predetermined distance from each other along the axis of the shaft 81 substantially parallel to each other. The first and second rollers 96a, 96b are linearly arrayed along the axis of the shaft 81, as shown in FIG. 2.

The loading mechanism 58 comprises the rotational drive source 57, which is mounted on an upper surface of the upper end plate 85a, a rotational shaft 102 disposed in a space 116 defined in the casing frame 94 and rotatably supported by first and second bearings 100a, 100b mounted in the casing frame 94, and a rotor 104 integrally mounted substantially centrally on the rotational shaft 102 for rotation about its own axis upon energization of the rotational drive source 57.

The rotational drive source 57, which may be a stepping motor, for example, has a downwardly extending drive shaft 106, as shown in FIG. 3. When the rotational drive source 57 is energized by a power supply (not shown), the drive shaft 106 rotates about its own axis. The drive shaft 106 extends through an insertion hole 108 defined in the upper end plate 85a and the casing frame 94 into the casing frame 94. A pinion (gear) 110 having a plurality of teeth on its outer circumferential surface is mounted on the lower end of the drive shaft 106.

The casing frame 94 has a first mount hole 112a defined in an upper wall thereof and a second mount hole 112b defined in a lower wall thereof. The first mount hole 112a and the second mount hole 112b are vertically aligned with each other across the space 116 in the casing frame 94. The rotational shaft 102, which is disposed substantially parallel to the vertical axis of the casing 92, has upper and lower ends rotatably supported by respective first and second bearings 100a, 100b mounted respectively in the first mount hole 112a and the second mount hole 112b. The rotational shaft 102 is supported substantially parallel to the drive shaft 106 by the first and second bearings 100a, 100b.

The rotational shaft 102 has an annular recess (not shown) defined substantially centrally therein, and the rotor 104 is integrally mounted in the recess in the rotational shaft 102, the rotor 104 being substantially circular and installed in the space 116 of the casing frame 94. The rotor 104 is mounted on and secured so as to not rotate with respect to the rotational shaft 102 by a spline groove or slot (not shown) defined in the rotational shaft 102 and a key (not shown) inserted into the slot, so that the rotor 104 is rotatable in unison with the rotational shaft 102.

A ring gear 118 is fitted over an upper portion of the rotor 104 and has a plurality of teeth mounted on its outer circumferential surface. The teeth of the ring gear 118 are held in mesh with the teeth of the pinion 110 mounted on the drive shaft 106. When the pinion 110 is rotated by the drive shaft 106 upon energization of the rotational drive source 57, the ring gear 118 held in mesh with the pinion 110 rotates the rotor 104 and the rotational shaft 102 about its own axis.

An annular guide 120 is disposed on the outer circumferential surface of the rotor 104 and projects radially outwardly a predetermined length therefrom. The guide 120 has a thickness T (see FIGS. 8 and 9) between its upper and lower surfaces which is substantially uniform in the circumferential direction of the guide 120.

The guide 120 lies in a horizontal space between the first and second rollers 96a, 96b mounted on the joint shaft 90. The upper surface of the guide 120 is held against the first roller 96a on the upper side and the lower surface of the guide 120 is held against the second roller 96b on the lower side.

Since the first and second rollers 96a, 96b sandwich the guide 120 in rolling contact therewith, when the rotor 104 is rotated by the rotational drive source 57, the first and second rollers 96a, 96b are rotated in abutment against the upper and lower surfaces of the guide 120. The guide 120 is kept vertically between the first and second rollers 96a, 96b in rolling engagement therewith and is not vertically displaceable in the axial direction of the joint shaft 90 on which the first and second rollers 96a, 96b are mounted.

The upper and lower surfaces of the guide 120 include flat and concave/convex surfaces as described below. When the guide 120 is rotated, the first and second rollers 96a, 96b in rolling engagement with the guide 120 are vertically displaced by the guide 120, causing the joint shaft 90 to displace the shaft 81 vertically in its axial direction.

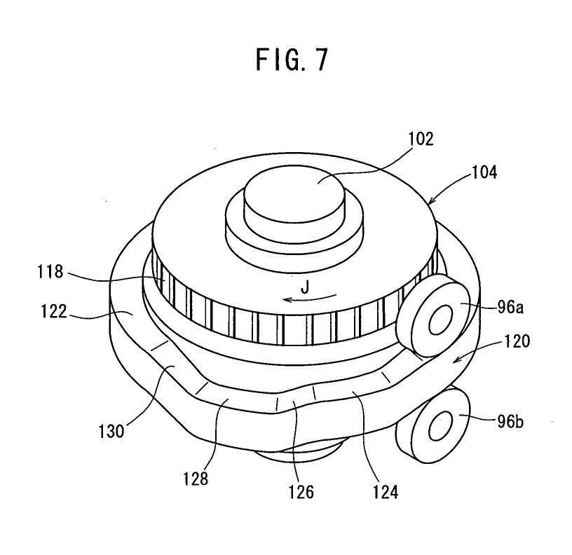

As shown in FIGS. 7 and 8, the guide 120 is shaped to have its vertical position varying along its circumferential direction in the axial direction of the rotor 104.

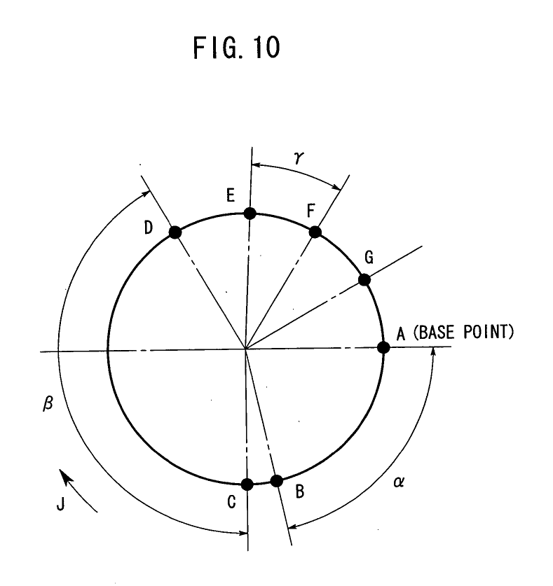

It is assumed, for example, that, as shown in FIG. 10, a base point serving as a reference on the outer circumferential surface of the guide 120 (see FIG. 7) on the rotor 104 is indicated as a point A. The circumferential shape of the guide 120 in a clockwise direction from the point A (direction of arrow J) will be described in detail below.

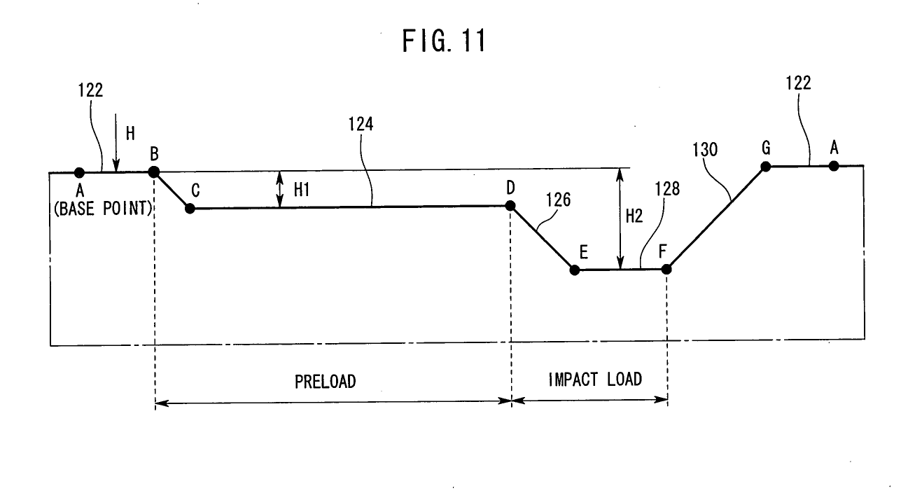

The guide 120 has a flat section 122 (see FIG. 11) extending in an angular range a (see FIG. 10) from the point A to a point B, the flat section 122 having substantially the same height or vertical position H in the axial direction of the rotor 104 and lying substantially horizontally.

As shown in FIG. 11, the guide 120 is gradually slanted downwardly from the point B to a point C, and has a first step section 124 extending in an angular range β (see FIG. 10) from the point C to a point D. The first step section 124 lies in a vertical position that is lower than the vertical position H of the point A by a predetermined height H1.

The guide 120 has a first slanted section 126 which is gradually inclined downwardly from the point D to a point E, and has a second step section 128 extending in an angular range γ from the point E to a point F. The second step section 128 is contiguous to the first slanted section 126 and lies in a vertical position that is lower than the vertical position H of the point A by a predetermined height H2 (H1<H2).

The guide 120 has a second slanted section 130 which is gradually inclined upwardly from the point F to a point G. The second slanted section 130 is joined to the flat section 122 at the point G where its vertical position is substantially the same as the vertical position H of the point A. The flat section 122, the first step section 124, and the second step section 128 are successively joined by the first slanted section 126 and the second slanted section 130.

The flat section 122, the first step section 124, and the second step section 128 are successively formed in the direction indicated by the arrow J in FIG. 7 in which the rotor 104 rotates.

As shown in FIGS. 2 and 3, the various components of the cracking apparatus 50 are mounted in the casing 92. The shaft 81 is axially slidably supported and limited against radial movement by the bushing 88b mounted in the hole 86a in the upper end plate 85a.

The casing 92, which is formed by the upper end plate 85a, the lower end plate 85b and the casing frame 94, supports on a side panel thereof a control/display console 132 for allowing the operator to operate the cracking apparatus 50 and to enter desired data, and also for displaying the entered data together with the operating status of the cracking apparatus 50. The control/display console 132 is connected to a control board 134 which controls the cracking apparatus 50 as a whole.

The cracking apparatus 50 according to the first embodiment is basically constructed as described above. Operation of the cracking apparatus 50 and its advantages will be described below.

First, the one-piece connecting rod 30 is set on the support base 60 of the workpiece holding mechanism 52 (see FIG. 5). At this time, the connecting rod 30 is positioned at the smaller end 40 by the fixing pin 62 with the spreaders 74, 76 fitted into the joint hole 36 in the larger end 38. The guide 120 on the rotor 104 has its flat section 122 engaged between the first and second rollers 96a, 96b.

Then, hydraulic fluid is supplied under pressure from a hydraulic fluid source to the hydraulic cylinder 82, which is actuated to move the piston 84 downwardly, causing the step surface 80a engaging the step 84a to move the piston rod 80 downwardly (see FIG. 8).

At the same time, a power supply (not shown) supplies an electric current through the control board 134 to the rotational drive source 57, which is energized to rotate the pinion 110 coupled to the drive shaft 106. The ring gear 118 which is held in mesh with the pinion 110 rotates the rotor 104. When the rotor 104 is rotated, the guide 120 engaged between the first and second rollers 96a, 96b is rotated clockwise in the direction indicated by the arrow J. When the guide 120 is thus rotated, the flat section 122 and then the points B, C successively move out of engagement with the first and second rollers 96a, 96b, and the first step section 124 moves into engagement with the first and second rollers 96a, 96b, causing the joint shaft 90 to move downwardly by the height H1.

The axial downward displacement of the piston rod 80 caused by the hydraulic cylinder 82 is substantially the same as the height H1 between the flat section 122 and the first step section 124 on the rotor 104. Therefore, when the shaft 81 and the joint shaft 90 are displaced downwardly by the piston rod 80 of the hydraulic cylinder 82, the first and second rollers 96a, 96b mounted on the joint shaft 90 are allowed to shift from the flat section 122 to the first step section 124 while in rolling engagement with the guide 120, following the downward displacement of the joint shaft 90.

Stated otherwise, the displacement of the shaft 81, which is caused by the hydraulic cylinder 82 for preloading the wedge 78, is linked operatively with the rotation of the rotor 104, which is caused by the rotational drive source 57 for displacing the flat section 122 out of engagement with the first and second rollers 96a, 96b and displacing the first step section 124 into engagement with the first and second rollers 96a, 96b.

When the piston rod 80 is displaced downwardly by the hydraulic cylinder 82, the wedge 78 coupled to the piston rod 80 is urged downwardly and hence is preloaded. The wedge 78 is now pressed into the recesses 74c, 76c of the spreaders 74, 76. The spreader 76 is displaced outwardly away from the spreader 74 as the wall 76d slides against the tapered surface 78b of the wedge 78. The spreaders 74, 76 are pressed against the inner surface of the joint hole 36 in the larger end 38.

The preload applied to the wedge 78 is adjusted in the above range (from about 0 to 49 kN) to the extent that even though the spreaders 74, 76 are pressed against the inner surface of the joint hole 36, the larger end 38 is not fractured, that is, the larger end 38 is only elastically deformed. The larger end 38 and the spreaders 74, 76 are free of wobbling movement, and the connecting rod 30 is reliably retained in place by the spreaders 74, 76.

While the wedge 78 is preloaded, the first and second rollers 96a, 96b are held in rolling engagement with the first step section 124 of the guide 120 on the rotor 104.

Substantially at the same time, the hydraulic cylinder 68a is actuated to insert the slide pins 64a, 64b into the respective bolt holes 42a, 42b to hold the connecting rod 30 laterally from the side of the larger end 38 in the direction indicated by the arrow X in FIG. 4. At this time, the pressers 70, 72 are actuated to press the larger end 38 from its opposite sides at the cracking areas 44a, 44b in the directions indicated by the arrow Y in FIG. 4.

Upon continued rotation of the rotor 104, the first step section 124, the point D, the first slanted section 126, and the point E of the guide 120 successively move out of engagement with the first and second rollers 96a, 96b, and the second step section 128 moves into engagement with the first and second rollers 96a, 96b. The second step section 128 is axially spaced downwardly from the first step section 124 which has been engaged by the first and second rollers 96a, 96b. Consequently, when the first and second rollers 96a, 96b are displaced out of rolling engagement with the first step section 124 into rolling engagement with the second step section 128, the joint shaft 90 on which the first and second rollers 96a, 96b are mounted and the shaft 81 coupled to the joint shaft 90 are forcibly displaced downwardly.

When the shaft 81 is displaced downwardly, it applies an impact load to the wedge 78 through the piston rod 80.

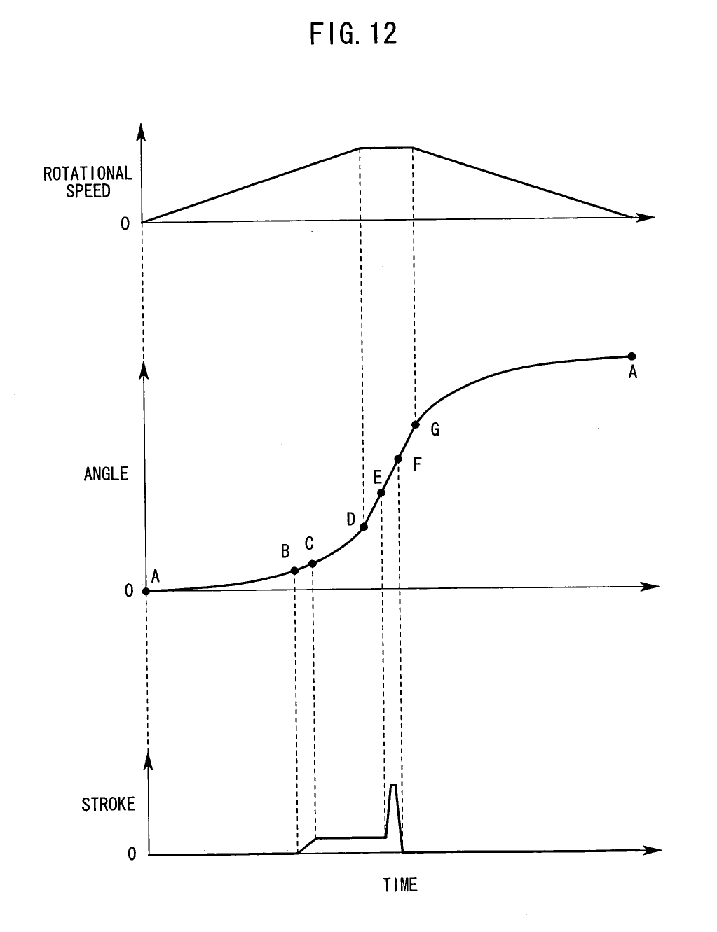

At this time, as shown in FIG. 12, the rotational speed of the rotational drive source 57 is increased while the first and second rollers 96a, 96b are held in engagement with the guide 120 and move through the second stepped section 128 from the point D to the point G, thus increasing the rotational speed of the rotor 104. Therefore, the joint shaft 90 and the shaft 81 are displaced at an increased speed, thus increasing the impact load applied through the piston rod 80 to the wedge 78. The increased rotational speed of the rotor 104 while the first and second rollers 96a, 96b are held in engagement with the guide 120 from the point D to the point G is essentially constant.

The downward displacement (stroke) of the piston 84 and the piston rod 80 under the hydraulic pressure of the hydraulic cylinder 82 is operatively linked mutually with the amount of rotation and rotational speed of the rotor 104, which is rotated under the rotational drive power of the rotational drive source 57.

At this time, since the piston 84 of the hydraulic cylinder 82 is separable with respect to the shaft 81, in a direction opposite to the direction in which the wedge 78 is pressed, i.e., in a direction opposite to the direction in which the impact load is applied to the wedge 78, a predetermined impact load is reliably applied to the wedge 78 without being dampened by the hydraulic cylinder 82.

The wedge 78 is therefore further pressed into the recesses 74c, 76c in the spreaders 74, 76. The spreader 76 is displaced outwardly further away from the spreader 74 as the wall 76d slides against the tapered surface 78b of the wedge 78. The larger end 38 is now subjected to stresses greater than the elastically deformable limit thereof, and hence is fractured into the cap 32 and the rod 34 at the cracking areas 44a, 44b on which stresses have been concentrated by the pressers 70, 72 (see FIG. 1B). At this time, the fractured cap 32 is prevented from being scattered because it is retained by the slide pins 64a, 64b urged by the hydraulic cylinder 68a (see FIG. 4).

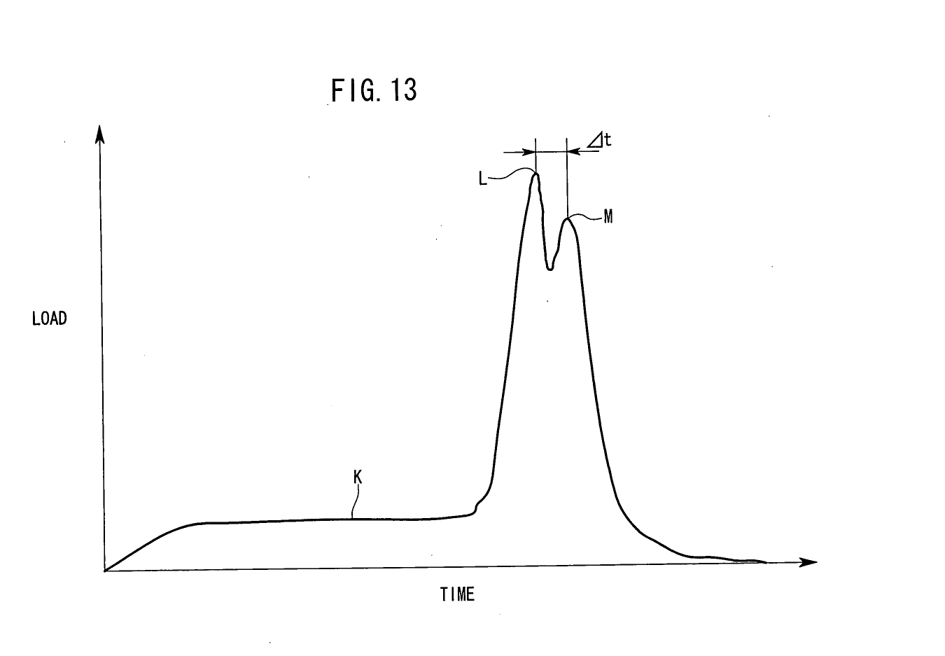

For the cracking apparatus 50 to crack the connecting rod 30 into the cap 32 and the rod 34, as shown in FIG. 13, the connecting rod 30 is preloaded for a certain period of time by the preloading mechanism 56 (see K in FIG. 13). Thereafter, the loading mechanism 58 imparts an impact load to the connecting rod 30 to fracture the cracking area 44a (see L in FIG. 13) and then the other cracking area 44b (see M in FIG. 13) after a slight time lag Δt. When the connecting rod 30 is cracked, the load applied thereto changes with time as shown in FIG. 13.

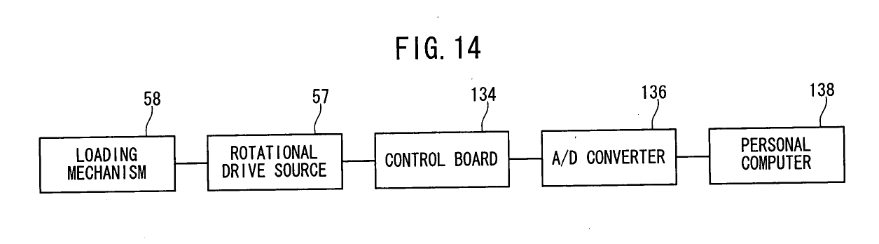

As shown in FIG. 14, the control board 134 for supplying electric current to the rotational drive source 57 of the cracking apparatus 50 is connected to an A/D converter 136 that is connected to a personal computer (processor) 138. When the preload and the impact load are applied to the connecting rod 30 by the hydraulic cylinder 82 and the rotational drive source 57, an analog signal based on the drive torque of the rotational drive source 57 and the rotational speed thereof is converted by the A/D converter 136 into a digital signal, which is output to the personal computer 138. The personal computer 138 then performs a processing operation and a corrective operation based on the digital signal, and displays on its display screen a load vs. time curve based on the drive torque of the rotational drive source 57 and the rotational speed thereof, as shown in FIG. 13.

Specifically, preset preload and impact load magnitudes, and times at which the preload and the impact load are applied, are input to the personal computer 138 in advance. When the connecting rod 30 is cracked, an output signal which is produced based on the drive torque of the rotational drive source 57 and the rotational speed thereof is compared with the processed and corrected output from the personal computer 138 to confirm whether the connecting rod 30 has been cracked properly or not. Consequently, management of quality and production control, at the time the connecting rod 30 is cracked, can efficiently be performed using the personal computer 138.

Furthermore, management of quality and production control can also be performed by comparing the magnitude of the fracturing time difference Δt, between the time when the cracking area 44a is fractured and the time when the cracking area 44b is fractured. Specifically, if the time difference Δt is unduly large, then the quality of the connecting rod 30 may be unacceptably low. However, a feedback control process may be carried out to output an electric signal to the rotational drive source 57, so that the fracturing time difference Δt detected by the personal computer 138 will be equalized to a preset optimum fracturing time difference Δt. In this manner, the detected fracturing time difference Δt can be optimized for stabilizing and increasing the quality of the connecting rod 30.

In the first embodiment, the preloading mechanism 56 employs a hydraulic cylinder 82. However, the preloading mechanism 56 may employ weights or elastic members such as springs for generating the preload.

In the first embodiment, as described above, when the connecting rod 30 is cracked by the cracking apparatus 50, the drive torque of the rotational drive source 57 and the rotational speed thereof are detected and supplied through the A/D converter 136 to the personal computer 138, and then processed and corrected thereby. In this manner, values of the preload and the impact load that are applied to the wedge 78 by the rotor 104 of the loading mechanism 58, as they change with time, can be constantly displayed or output as a load vs. time curve (see FIG. 13) by the personal computer 138.

As a result, the load applied to the connecting rod 30 at the time it is cracked can easily be confirmed on the display screen of the personal computer 138, or through some other output form, for facilitating quality control at the time the larger end 38 of the connecting rod 30 is fractured.

Output data representative of the values of the loads applied to the connecting rod 30 as they vary with time may be saved and stored. The stored output data may be used to compare load values, load application times and the like applied to crack connecting rods 30 that are being manufactured at present with the load values, load application times and the like applied to crack the connecting rods 30 that were manufactured in the past. Quality control can also be performed for each of the individual connecting rods 30 that are manufactured in a batch.

For cracking connecting rods 30, it is the general practice to manufacture a plurality of connecting rods 30 belonging to each connecting rod type in a single lot. By controlling loads and times for applying the loads, while cracking each of the connecting rods 30 in the same lot, the quality of the connecting rods 30 in the same lot can be stabilized for facilitating production management.

Since the loads and times for applying the loads can also be compared between different manufactured lots, the detected loads and preset optimum loads can be compared between differently manufactured lots, to control and supply electric current to the rotational drive source 57 for achieving optimum loads. In this manner, the quality of the connecting rods 30 from different manufactured lots can further be stabilized for better production management efficiency.

For fracturing the larger end 38 of the connecting rod 30, the rotor 104 of the loading mechanism 58 is rotated by the rotational drive source 57 to displace the shaft 81 for thereby applying the impact load. The loading mechanism 58 is effective in reducing noise produced when the impact load is applied, thus improving the manufacturing environment where the connecting rods 30 are manufactured.

The shape of the guide 120 on the outer circumferential surface of the rotor 104, i.e., the shapes of the flat section 122, the first step section 124, and the second step section 128, may be changed as desired, and the hydraulic cylinder 82 may be controlled to displace the piston rod 80 depending on the shape of the guide 120, so that the magnitudes of the preload and the impact load that are applied to the wedge 78, and the times for which the preload and the impact load are applied to the wedge 78 for fracturing the larger end 38 of the connecting rod 30, can be freely adjusted.

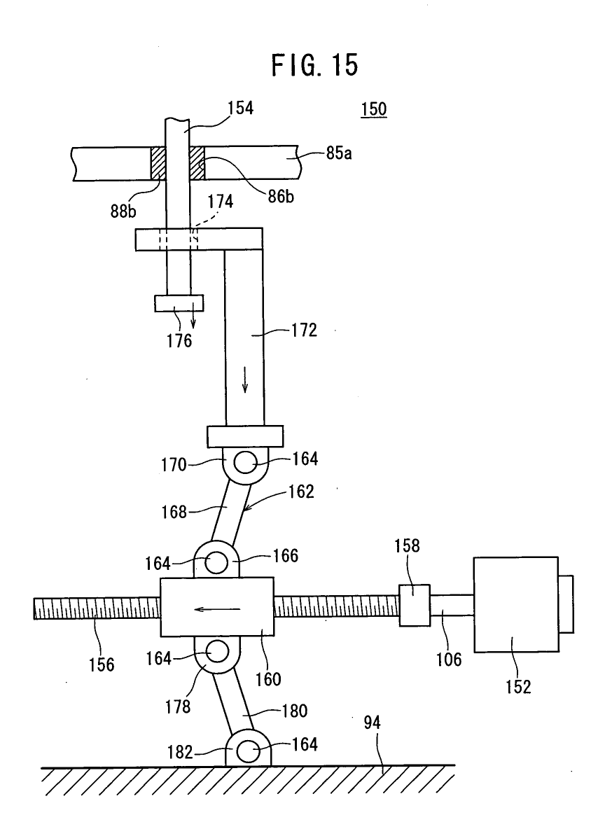

FIG. 15 shows a cracking apparatus 150 for cracking a connecting rod 30 according to a second embodiment of the present invention. Those parts of the cracking apparatus 150 which are identical to those of the cracking apparatus 50 according to the first embodiment are denoted by identical reference characters, and shall not be described in detail below.

The cracking apparatus 150 for cracking a connecting rod 30 according to the second embodiment comprises a rotational drive source 152, having an axis extending substantially perpendicularly to the axis of a vertical shaft 154 that extends through the upper end plate 85a. The rotational drive source 152 has a drive shaft 106 integrally connected to an externally threaded ball screw 156 by a coupling 158. The externally threaded ball screw 156 is threaded through an internally threaded rectangular displacement member 160, which has upper and lower surfaces connected to a link mechanism 162.

Specifically, the link mechanism 162 includes a first link support 166 mounted on the upper surface of the displacement member 160, and a first arm 168 having an end angularly movably supported on the first link support 166 by a link pin 164 pivotally mounted thereon. The first arm 168 has another end supported on a second link support 170 by a link pin 164 pivotally mounted thereon. The second link support 170 is mounted on the lower end of a joint arm 172 having a substantially L-shaped cross section. The joint arm 172 is axially displaceably supported by a guide mechanism (not shown) and has an upper portion extending substantially horizontally and having an insertion hole 174 defined therein. The vertical shaft 154 is axially displaceably inserted through the insertion hole 174. A flange 176, having an enlarged diameter, is mounted on the lower end of the vertical shaft 154.

The link mechanism 162 also includes a third link support 178 mounted on the lower surface of the displacement member 160, and a second arm 180 having an end angularly movably supported on the third link support 178 by a link pin 164 pivotally mounted thereon. The second arm 180 has another end supported on a fourth link support 182 by a link pin 164 pivotally mounted thereon. The fourth link support 182 is connected internally to the casing frame 94.

When the rotational drive source 152 is energized, the ball screw 156 is rotated about its own axis by the drive shaft 106, thereby displacing the displacement member 160 away from the rotational drive source 152. The first arm 168 displaces the joint arm 172 downwardly, pushing the flange 176 on the shaft 154 downwardly. Thus, the shaft 154 is pressed downwardly to impart an impact load to the wedge 78 (see FIGS. 2 and 3) coupled to the shaft 154.

According to the second embodiment, the rotational drive power of the rotational drive source 152 is transmitted through the link mechanism 162 to the joint arm 172. The pitch of the ball screw 156 is selected such that the displacement speed of the displacement member 160 increases as the displacement member 160 is displaced a larger distance on the ball screw 156. Since the joint arm 172 is axially displaced at a higher speed as it is displaced by a larger distance, the force applied from the joint arm 172 to the flange 176 to pull the flange 176 downwardly increases as the joint arm 172 is displaced a larger distance, and a greater impact load is applied to the wedge 78.

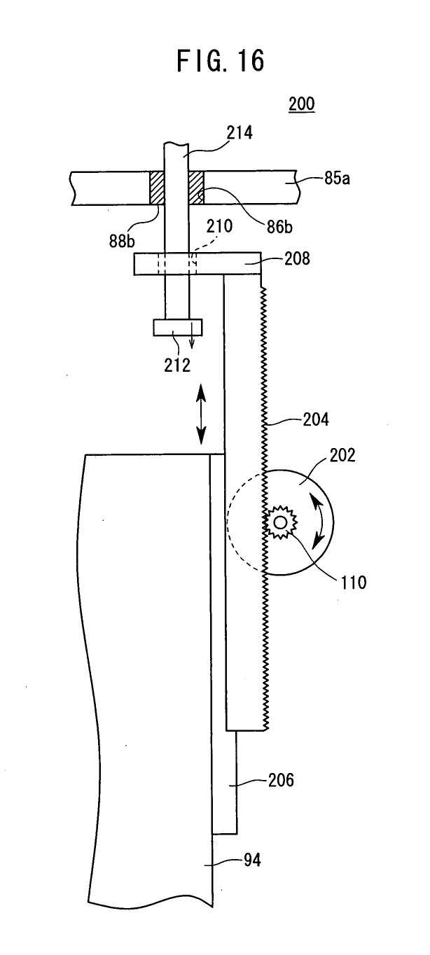

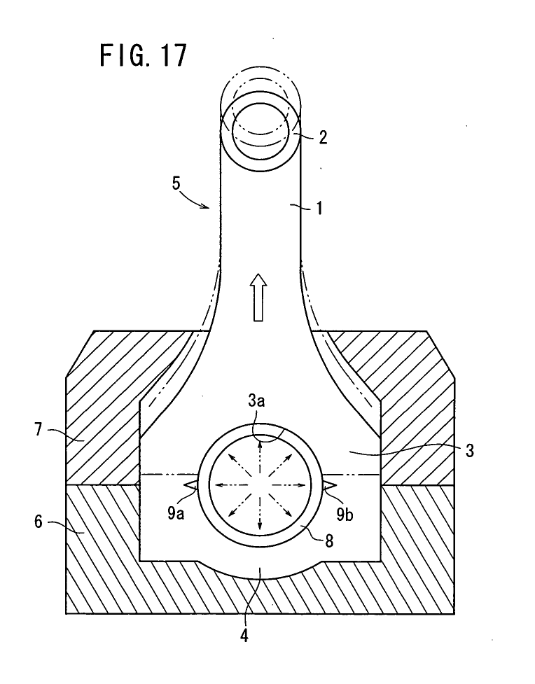

FIG. 16 shows a cracking apparatus 200 for cracking the connecting rod 30 according to a third embodiment of the present invention. Those parts of the cracking apparatus 200 which are identical to those of the cracking apparatus 50 according to the first embodiment are denoted by identical reference characters, and shall not be described in detail below.

The cracking apparatus 200 has a rotational drive source 202 having an axis extending substantially perpendicularly to the axis of a vertical shaft 214 that extends through the upper end plate 85a. A vertical elongate rack (meshing member) 204 is mounted on the casing frame 94, and the rotational drive source 202 has a drive shaft (unnumbered) integrally connected to a pinion 110 which is held in mesh with the rack 204. The rack 204 extends substantially parallel to the shaft 214 and is axially displaceably guided by a guide 206 mounted on an inner surface of the casing frame 94.

A presser 208 extending substantially perpendicular to the axis of the rack 204 is mounted on the upper end of the rack 204 and has an insertion hole 210 defined therein. The vertical shaft 214 is axially displaceably inserted through the insertion hole 210. A flange 212, having an enlarged diameter, is mounted on the lower end of the vertical shaft 214.

When the rotational drive source 202 is energized, the pinion 110 is rotated integrally therewith, displacing the rack 204 held in mesh with the pinion 110 axially downwardly. The rack 204 displaces the presser 208 downwardly in unison therewith, pushing the flange 212 on the shaft 214 downwardly. The shaft 214 is pressed downwardly to impart an impact load to the wedge 78 coupled to the shaft 214.

According to the third embodiment, the outside diameter of the pinion 110, which is held in mesh with the rack 204, may be changed to change the speed at which the rack 204 is displaced. Consequently, the magnitude of the impact load applied to the wedge 78 (see FIGS. 2 and 3) can easily be changed.

Although certain preferred embodiments of the present invention have been shown and described in detail, it should be understood that various changes and modifications may be made therein without departing from the scope of the appended claims.

1. An apparatus for cracking a one-piece connecting rod having a larger end and a smaller end by setting a joint hole defined in the larger end over a pair of spreaders and pressing a wedge in between said spreaders to move the spreaders away from each other, thereby fracturing said larger end into a cap and a rod, comprising:
a preloading mechanism for applying a preload to said wedge in the direction in which said wedge is pressed, to press said spreaders against an inner surface of said joint hole in said larger end; and
a loading mechanism for applying an impact load to said wedge in the direction in which said wedge is pressed to fracture said larger end;
said loading mechanism comprising:
a rotational drive source;
a rotor rotatable by said rotational drive source;
an annular guide mounted on said rotor; and
a load transmitter connected to said wedge and engaging said guide for vertical displacement in unison with said wedge.

2. An apparatus according to claim 1, wherein said guide projects radially outwardly from an outer circumferential surface of said rotor and has a surface held in engagement with said load transmitter and continuously changing in the direction in which said wedge is pressed.

3. An apparatus according to claim 2, wherein said guide comprises:
a flat section extending substantially horizontally;
a first step section extending contiguously to said flat section and spaced away from said wedge substantially parallel to said flat section; and
a second step section extending contiguously to said first step section and spaced away from said wedge substantially parallel to said first step section;
said flat section, said first step section, and said second step section being successively disposed in the direction in which said rotor rotates, and said flat section, said first step section, and said second step section being joined by slanted sections.

4. An apparatus according to claim 3, wherein said flat section has a height serving as a reference in the axial direction of said rotor, said first step section being spaced a predetermined distance from said flat section, and said second step section being spaced a greater distance from said flat section than said first step section.

5. An apparatus according to claim 2, wherein said load transmitter held in engagement with said flat section imparts the preload through said wedge to said connecting rod when shifted into engagement with said first step section, and imparts the impact load through said wedge to said connecting rod when shifted out of engagement with said first step section into engagement with said second step section.

6. An apparatus according to claim 2, wherein said guide has a substantially constant thickness in the axial direction of said rotor.

7. An apparatus according to claim 1, wherein said load transmitter comprises a shaft axially displaceable upon rotation of said rotor by rollers engaging said guide, for applying said impact load to said wedge, said preloading mechanism comprising a cylinder having a piston rod, said shaft being integrally formed with said piston rod.

8. An apparatus according to claim 7, wherein said shaft is coupled to said wedge.

9. An apparatus according to claim 1, wherein said preloading mechanism comprises a cylinder producing the preload, said cylinder comprising a piston rod for transmitting the preload to said wedge, and a piston displaceable in unison with said piston rod in the direction in which said wedge is pressed, said piston being movable in a direction opposite to the direction in which said wedge is pressed.

10. An apparatus according to claim 1, wherein said rotor supports on an outer circumferential surface thereof an annular ring gear having a plurality of teeth, said rotational drive source having a drive shaft supporting a gear thereon, said ring gear being held in mesh with said gear.

11. An apparatus according to claim 1, wherein said connecting rod has a pair of cracking areas positioned as boundary areas between the cap and the rod of said larger end near said joint hole.

12. An apparatus according to claim 11, further comprising:
a workpiece holding mechanism for holding said connecting rod;
said workpiece holding mechanism comprising a pair of pressers for pressing opposite sides of said connecting rod at positions confronting said cracking areas, respectively.

13. An apparatus according to claim 12, wherein said workpiece holding mechanism has a pair of slide pins insertable respectively into a pair of bolt holes defined in said larger end of said connecting rod.

14. An apparatus according to claim 1, wherein said spreaders have substantially semicircular outer circumferential surfaces, respectively, and have respective outside diameters which are substantially identical to the inside diameter of said joint hole.

15. An apparatus according to claim 1, wherein said wedge has a tapered surface facing an inner surface of one of said spreaders and progressively spreading in a direction opposite to the direction in which said wedge is pressed, said one of the spreaders having a tapered wall held against said tapered surface.

16. An apparatus according to claim 1, further comprising a control board, a converter connected to said rotational drive source by said control board, for converting an analog signal output from said rotational drive source into a digital signal, and a processor connected to said converter for processing said digital signal output from said converter to detect and process a rotational output of said rotational drive source.

17. An apparatus according to claim 1, wherein said loading mechanism comprises:
a ball screw connected to a drive shaft of said rotational drive source, said ball screw being externally threaded;
a displacement member threaded over said ball screw for axial displacement upon rotation of said ball screw;
a joint arm connected to said displacement member by a link mechanism; and
a shaft extending through said joint arm and connected to said wedge;
whereby when said ball screw is rotated, said displacement member is axially displaced to cause said link mechanism to displace said joint arm axially for thereby applying the impact load through said shaft to said wedge in the direction in which said wedge is pressed.

18. An apparatus according to claim 1, wherein said loading mechanism comprises:
a gear mounted on a drive shaft of said rotational drive source, said gear having a plurality of teeth;
a meshing member meshing with said gear and guided for axial displacement; and
a shaft extending through said meshing member and connected to said wedge;
whereby when said rotational drive source is energized, said meshing member is axially displaced by said gear for thereby applying the impact load through said shaft to said wedge in the direction in which said wedge is pressed.

19. A method of cracking a one-piece connecting rod having a larger end and a smaller end by setting a joint hole defined in the larger end over a pair of spreaders and pressing a wedge in between said spreaders to move the spreaders away from each other, thereby fracturing said larger end into a cap and a rod, comprising the steps of:
applying a preload to said wedge in the direction in which said wedge is pressed to press said spreaders against an inner surface of said joint hole in said larger end; and
applying an impact load to said wedge in the direction in which said wedge is pressed to fracture said larger end, by rotating a rotor with a rotational drive source to displace a load transmitter axially in engagement with a guide mounted on an outer circumferential surface of said rotor.

20. A method according to claim 19, wherein a processor is connected to said rotational drive source for detecting and processing a rotational output of said rotational drive source, and displaying processed data based on the rotational output of said rotational drive source.
